(19) United States
(12) Patent Application Publication
(10) Pub. No.: US 2017/0046728 A1
(43) Pub. Date: Feb. 16, 2017

(54) QUERY AND DENSITY-BASED LOCATION ANALYSIS

(71) Applicant: Storefront, Inc., San Francisco, CA (US)

(72) Inventors: Keith Horwood, San Francisco, CA (US); Erik Eliason, San Francisco, CA (US)

(21) Appl. No.: 14/982,661

(22) Filed: Dec. 29, 2015

Related U.S. Application Data
(60) Provisional application No. 62/205,722, filed on Aug. 15, 2015.

(51) Int. Cl. G06Q 30/02; H04W 4/02; G06F 17/30

(52) U.S. Cl. CPC G06Q 30/0205; G06F 17/30241; G06F 17/3053; H04W 4/021

(57) ABSTRACT

A system and method for location analysis based on ratings of existing relevant establishments, including: receiving a request for location analysis comprising an indication of a target location; querying a data store for available venues matching a set of location types within a sample radius from the target location; receiving a set of venues and a set of associated ratings from the data store; scoring the set of venues according to scoring criteria, wherein the scoring criteria is used to score each of the set of venues based on the set of associated ratings; generating a resultant score for the target location based on the scoring of the set of venues; and returning, in response to the request for location analysis, the resultant score.

### CROSS-REFERENCE TO RELATED APPLICATIONS

This application claims the benefit of U.S. Provisional Application No. 62/205,722, “QUALITY-AWARE AND LOCATION-BASED ANALYSIS”, Attorney Docket storefront.00001.us.p.1, filed Aug. 15, 2015, the entire disclosure of which is incorporated by reference herein, in its entirety, for all purposes.

### BACKGROUND

Real estate property owners, landlords, property managers, real estate renters, developers, investors, city planners, and others can benefit from knowing how well a particular geographic location, e.g., a street address in a city, is or would be suited for a particular purpose. For example, an entrepreneur searching for a favorable retail establishment location can benefit from knowing how well a particular location would suit such a retail establishment. Likewise, a landlord of an existing retail establishment can benefit from knowing how well the location of the existing retail establishment is suited for one or more uses. Current technological solutions for location analysis are limited.

### SUMMARY

In general, in one aspect, embodiments relate to a system for rating-aware and query-based location analysis. The system can include: one or more computer processors; a location query subsystem executing on the one or more computer processors and configured to enable the one or more computer processors to receive a request to score an identified geographic location as a venue for a specified type of establishment; a database access subsystem executing on the one or more computer processors and configured to enable the one or more computer processors to obtain, from at least one online database, a geographic location and an associated set of ratings data for each of a set of existing establishments that are relevant to the venue; an impact evaluator subsystem executing on the one or more computer processors and configured to enable the one or more computer processors to generate, for each existing establishment, an impact indicator by determining an impact of the geographic location of the corresponding existing establishment on the venue and combining the impact with the ratings of the corresponding existing establishment; and a data normalizer subsystem executing on the one or more computer processors and configured to enable the one or more computer processors to combine the impact indicators into a quality score such that the quality score, when presented to a user via the location query subsystem, provides a relative indication of a quality of the identified geographic location as the venue.

In general, in one aspect, embodiments relate to a method for rating-aware location analysis. The method can include: receiving a request to score an identified geographic location as a venue for a specified type of establishment; obtaining a geographic location and an associated set of ratings data from at least one online database for each of a set of existing establishments that are relevant to the venue; generating an impact indicator for each existing establishment by determining an impact of the geographic location of the corresponding existing establishment on the venue and combining the impact with the ratings of the corresponding existing establishment; and combining the impact indicators into a quality score for the venue such that the quality score, when presented to the user, provides a relative indication of a quality of the identified geographic location as the venue.

In general, in another aspect, embodiments relate to a system for rating-aware location analysis. The system can include: one or more computer processors; an analysis subsystem executing on the one or more computer processors and configured to enable the one or more computer processors to: receive a request for location analysis comprising an indication of a target location; query a data store for available venues matching a set of location types within a sample radius from the target location; receive a set of venues and a set of associated ratings from the data store; score the set of venues according to scoring criteria, wherein the scoring criteria is used to score each of the set of venues based on the set of associated ratings; generate a resultant score for the target location based on the scoring of the set of venues; and return, in response to the request for location analysis, the resultant score.

Other embodiments will be apparent from the following description and the appended claims.

### BRIEF DESCRIPTION OF THE DRAWINGS

Embodiments are illustrated by way of example, and not by way of limitation, in the figures of the accompanying drawings and in which like reference numerals refer to similar elements.

FIG. 1 illustrates a location analysis system in one or more embodiments.

FIG. 2 illustrates an example of a set of ratings data obtained from a set of online databases.

FIG. 3 shows how ratings data for existing establishments can be selected for analysis based on a maximum allowed distance from an identified geographic location.

FIG. 4 shows a mapping subsystem in one or more embodiments of a location analysis system.

FIG. 5 shows how a predetermined geographic area for a heat map can be represented by an array of grid locations.

FIG. 6 is a flowchart of a method for rating-aware location analysis in one or more embodiments.

FIG. 7 illustrates a system for rating-aware location analysis in one or more embodiments.

FIG. 8 is a flowchart of a method for rating-aware location analysis in one or more embodiments.

FIG. 9 illustrates an example of a computing system upon which one or more components of a rating-aware location analysis system can be deployed.

### DETAILED DESCRIPTION

A portion of the disclosure of this patent document may contain material that is subject to copyright protection. The copyright owner has no objection to the facsimile reproduction by anyone of the patent document or the patent disclosure, as it may appear in the Patent and Trademark Office patent file or records, but otherwise reserves all copyrights whatsoever.

Specific embodiments will now be described in detail with reference to the accompanying figures. Like elements in the various figures are denoted by like reference numerals for consistency. In the following detailed description of embodiments, numerous specific details are set forth in order to provide a more thorough understanding of the invention. However, it will be apparent to one of ordinary skill in the art that the invention can be practiced without these specific details. In other instances, well-known features have not been described in detail to avoid unnecessarily complicating the description.

In general, embodiments of the present disclosure provide methods and systems for rating-aware and query-based location analysis. For example, an analysis system may access ratings of existing relevant establishments through various databases and analyze media (text, images, videos, etc.) to evaluate a location. For example, the system may perform text-based language processing and analysis on user-submitted reviews or comments to determine rating values.

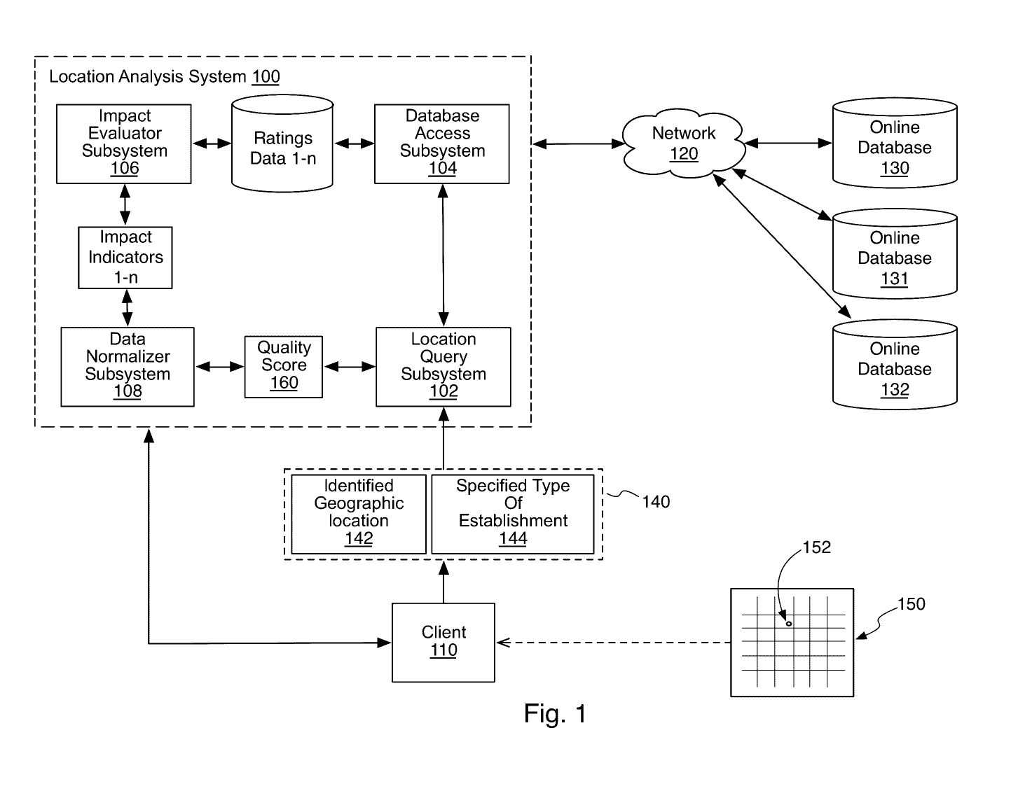

FIG. 1 illustrates a location analysis system 100 in one or more embodiments. The location analysis system 100 includes a location query subsystem 102 that receives a request 140 to score an identified geographic location 142 as a venue for a specified type of establishment 144. In some embodiments, the request 140 includes more or less information (e.g., including a sample radius and/or does not include a specified type of establishment).

The identified geographic location 142 can be a street address, a set of coordinates, e.g., latitude/longitude, global positioning system (GPS) coordinates, grid coordinates, survey coordinates, two or more cross streets, one or more transit stop identifiers, etc., to name a few examples.

The specified type of establishment 144 can be a relatively broad type, e.g., retail, education, commercial, wholesale, professional services, etc. The specified type of establishment 144 can be a relatively specific type, e.g., grocery store, clothing store, electronics store, restaurant, bar, coffee shop, law office, fitness establishment, healthcare establishment, nightclub, etc.

The request 140 in one or more embodiments is generated by a client 110 of the location analysis system 100. The client 110 can be a web client of the location analysis system 100. The client 110 can be a mobile device, e.g., smartphone, tablet, wearable, etc. The client 110 can run a mobile app adapted for accessing the location analysis system 100.

The client 110 can include a mechanism for generating the identified geographic location 142, e.g., a GPS receiver, a Wi-Fi receiver, software for accessing a web-based geo-location service, etc. For example, the identified geographic location 142 can correspond to a location 152 on a map 150 rendered via the client 110 that enables a user of the client 110 to select the location 152 for analysis.

The location analysis system 100 includes a database access subsystem 104. The database access subsystem 104 obtains a respective set of ratings data 1−n for each of a set of existing establishments that are relevant to evaluating the identified geographic location 142 as a venue for the specified type of establishment 144. In one or more embodiments, the database access subsystem 104 obtains the ratings data 1−n from a set of one or more online databases 130-132.

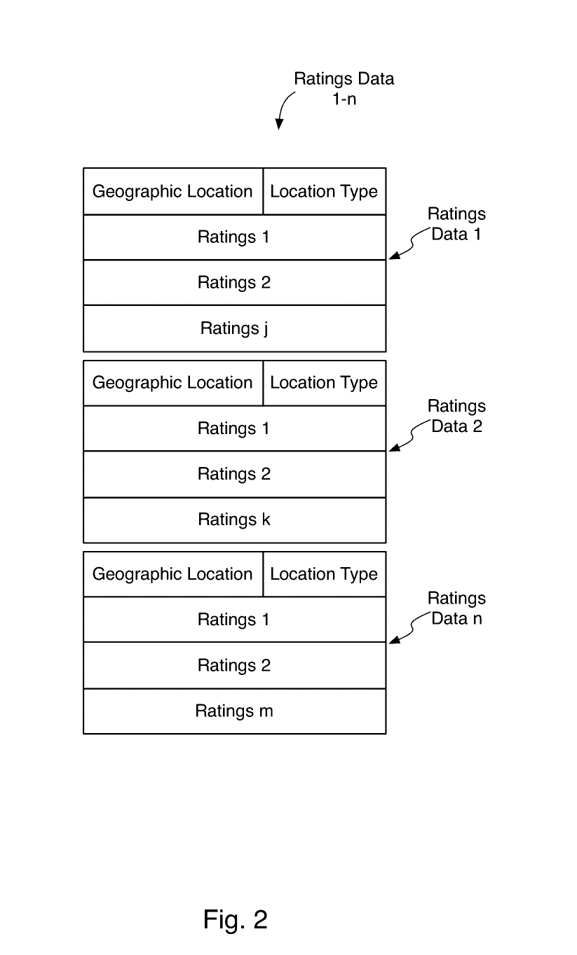

FIG. 2 illustrates the ratings data 1−n obtained from the online databases 130-132. Each set of ratings data 1−n corresponds to an existing establishment that is relevant to evaluating the identified geographic location 142 as a venue for the specified type of establishment 144. There can be any number, n, of sets of ratings data 1−n.

Each set of ratings data 1−n includes a geographic location, a location type, and a set of ratings. For example, the ratings data 1 includes a set of ratings 1−j for an existing establishment located at the geographic location specified in the ratings data 1 and described by the location type specified in the ratings data 1. There can be any number, j, of the ratings 1−j in the ratings data 1. Similarly, the ratings data n includes a set of ratings 1−m for an existing establishment at the geographic location specified in the ratings data n and described by the location type specified in ratings data n and there can be any number, m, of the ratings 1−m.

The geographic locations in the ratings data 1−n can be any type of geographic location indicator, e.g., street addresses, GPS coordinates, latitude/longitude, etc., or any combination thereof.

The location types in the ratings data 1−n can be any system of location types. Examples of location types that can be associated an existing establishment represented in the online databases 130-132 include retail, education, commercial, wholesale, professional services, grocery, clothing, electronics, restaurant, bar, coffee shop, law office, fitness, healthcare, nightclub, etc. An existing establishment can be associated with more than one location type.

The ratings 1−j, 1−k, through 1−m can be ratings according to any ratings system or any combination of ratings systems. Examples of ratings systems include star systems (e.g., 0-3 stars or 0-5 stars, etc.), ratings scales (e.g., 1-5 or 1-10), description based systems (e.g., high, medium, low, or poor through excellent, etc.). Any one or more of the ratings 1−j, 1−k, 1−m can include commentary, i.e., text descriptions of experiences of individuals pertaining to the corresponding existing establishments.

For example, if the specified type of establishment 144 is a retail establishment, then database access subsystem 104 gathers the ratings data 1−n from the online databases 130-132 for existing establishments that are relevant to a retail establishment at the identified geographic location 142. Examples of existing establishments relevant to a retail establishment at the identified geographic location 142 can include other retail establishments in the vicinity of the identified geographic location 142.

Likewise, if the specified type of establishment 144 is a nightclub, then database access subsystem 104 obtains the ratings data 1−n from the online databases 130-132 for existing establishments that are relevant to a nightclub at the identified geographic location 142. Examples of existing establishments relevant to a nightclub at the identified geographic location 142 can include other nightclubs in the vicinity of the identified geographic location 142, restaurants, cafes, theaters, and other venues that are likely to feed patron traffic at or otherwise improve the value of the identified geographic location 142.

Similarly, if the specified type of establishment 144 is a grocery store, then database access subsystem 104 obtains the ratings data 1−n for a set of existing establishments that are relevant to a grocery store at the identified geographic location 142. Examples of existing establishments that are relevant to a grocery store at the identified geographic location 142 can include other grocery and food markets in the vicinity of the identified geographic location 142, as well as drug stores, convenience stores, etc., and other venues that are likely to feed patron traffic at or otherwise improve the value of the identified geographic location 142. In some embodiments, the database access subsystem 104 obtains the ratings data 1−n for a set of existing establishments at or near the identified geographic location 142, regardless of relevance of the existing establishments to the specified type of establishment.

In one or more embodiments, the database access subsystem 104 obtains the ratings data 1−n from the online databases 130-132 using a public or a private application programming interface (API) for each of respective online databases 130-132. An API for the online databases 130-132 can enable the database access subsystem 104 to search for ratings data according to search criteria (e.g. geographic location, location type, keyword searches, etc.).

Referring again to FIG. 1, the location analysis system 100 includes an impact evaluator subsystem 106 that generates a set of impact indicators 1−n. Each impact indicator 1−n corresponds to a respective existing establishment represented in the ratings data 1−n. In one or more embodiments, the impact evaluator subsystem 106 generates each impact indicator 1−n by determining an impact of the geographic location of each corresponding existing establishment on the venue under evaluation (i.e., on the identified geographic location 142 as the specified type of establishment 144), and combining the impact with the corresponding ratings.

For example, the impact evaluator subsystem 106 generates the impact indicator 1 by determining an impact of the geographic location of the existing establishment specified in the ratings data 1 on the identified geographic location 142 as the venue for the specified type of establishment 144 and combining the impact with the ratings 1−j. Likewise, the impact evaluator subsystem 106 generates the impact indicator n by determining an impact of the geographic location of the existing establishment specified in the ratings data n on the identified geographic location 142 as the venue for the specified type of establishment 144 and combining the impact with the ratings 1−m.

The location analysis system 100 includes a data normalizer subsystem 108 that combines the impact indicators 1−n into a quality score 160. The quality score 160, when presented to a user (e.g., of the client 110), via the location query subsystem 102, provides a relative indication of a quality of the identified geographic location 142 as the venue for the specified type of establishment 144. For example, if the specified type of establishment 144 is a retail establishment, then the quality score 160 indicates a quality of the identified geographic location 142 as a venue for a retail establishment.

The quality score 160 can be any type/scale of quality score, e.g., a scale of 0-10, high/medium/low quality, star rating, etc. The impact indicators 1−n can be combined into the quality score 160 in a variety of ways. For example, a subset of the highest impact indicators 1−n can be multiplied together to form a product which is then normalized into a predetermined range (e.g., 0-100, 0-10, etc.).

In one or more embodiments, the database access subsystem 104 selects the ratings data 1−n from the online databases 130-132 based on one or more of the location types associated with each existing establishment. For example, if the specified type of establishment 144 is retail then the database access subsystem 104 can select the existing establishments from the online databases 130-132 having location types that are relevant to a retail establishment, e.g., retail or specific types of retail.

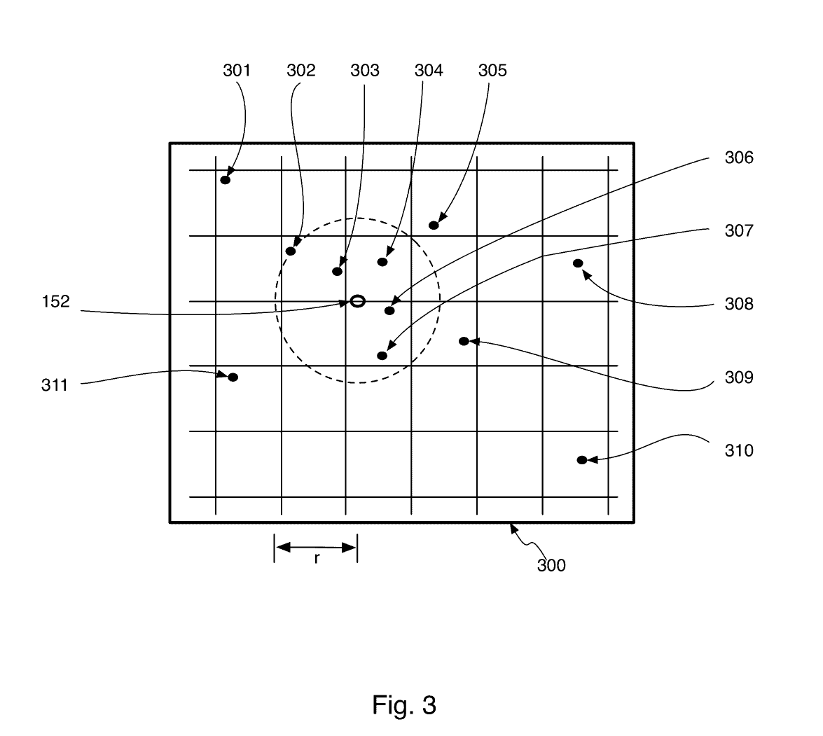

FIG. 3 is a grid 300 showing how the database access subsystem 104 can select the ratings data 1−n from the online databases 130-132 based on a maximum allowed distance of the existing establishments from the identified geographic location 142. The grid 300 shows the location 152 corresponding to the identified geographic location 142. The grid 300 also shows a respective location 301-311 of each of a set of existing establishments for which ratings data are available in the online databases 130-132.

In one or more embodiments, the database access subsystem 104 selects only the existing establishments that are within a radius r of the location 152 as being relevant to the identified geographic location 142 as a venue for the specified type of establishment 144. In this example, the relevant existing establishments are those at the locations 302, 303, 304, 306, and 307.

In one or more embodiments, the database access subsystem 104 determines the respective distances from each of the locations 302, 303, 304, 306, and 307 to the location 152 according to the haversine distance formula that yields great-circle distances between two points on a sphere in response to the longitudes and latitude of the two points.

In one or more embodiments, the impact evaluator subsystem 106 determines the impact indicators 1−n by determining a distance factor for each existing establishment based on a geographical distance between the identified geographic location 142 and the existing establishment and the maximum allowed distance. For example, the impact evaluator subsystem 106 can determine the impact indicator 1 by determining a distance factor df based on a geographical distance d between the identified geographic location 142 and the geographical location specified in the ratings data set 1 and a maximum allowed distance r (e.g., df=d/r).

In one or more embodiments, the impact evaluator subsystem 106 determines the impact indicators 1−n by normalizing the corresponding ratings and determining a ratio of the corresponding ratings to the corresponding distance factor. For example, the impact evaluator subsystem 106 can generate the impact indicator 1 by normalizing the ratings 1−j (e.g., into a predetermined range 1≦ratings 1−j≦5), and dividing the normalized ratings by the corresponding distance factor df for the existing establishment specified in the ratings data set 1.

Any commentary included in the ratings 1−j, 1−k, 1−m can be factored into the respective impact indicators 1−n in a variety of ways. For example, keywords found in commentary can be classified as positive or negative including degrees of positivity and negativity which can be used to adjust the normalized ratings accordingly. Specific keywords if present can be used to disqualify the corresponding existing establishment from consideration in the evaluation of the identified geographic location 142 as a venue for the specified type of establishment 144.

In one or more embodiments, the data normalizer 108 culls the impact indicators 1−n by discarding all but a predetermined number of the impact indicators corresponding to a set of highest values among the impact indicators 1−n. For example, the data normalizer 108 can cull the impact indicators 1−n by discarding all but the 10 highest values of the impact indicators 1−n.

In one or more embodiments, the location query subsystem 102 obtains the request 140 by generating a web-based user interface that enables a user of the client 110 to specify the identified geographic location 142 and select the specified type of establishment 144 (e.g. by entering a street address, clicking on a map in the web-based user interface, etc.), and selecting from among a list of location types, etc.

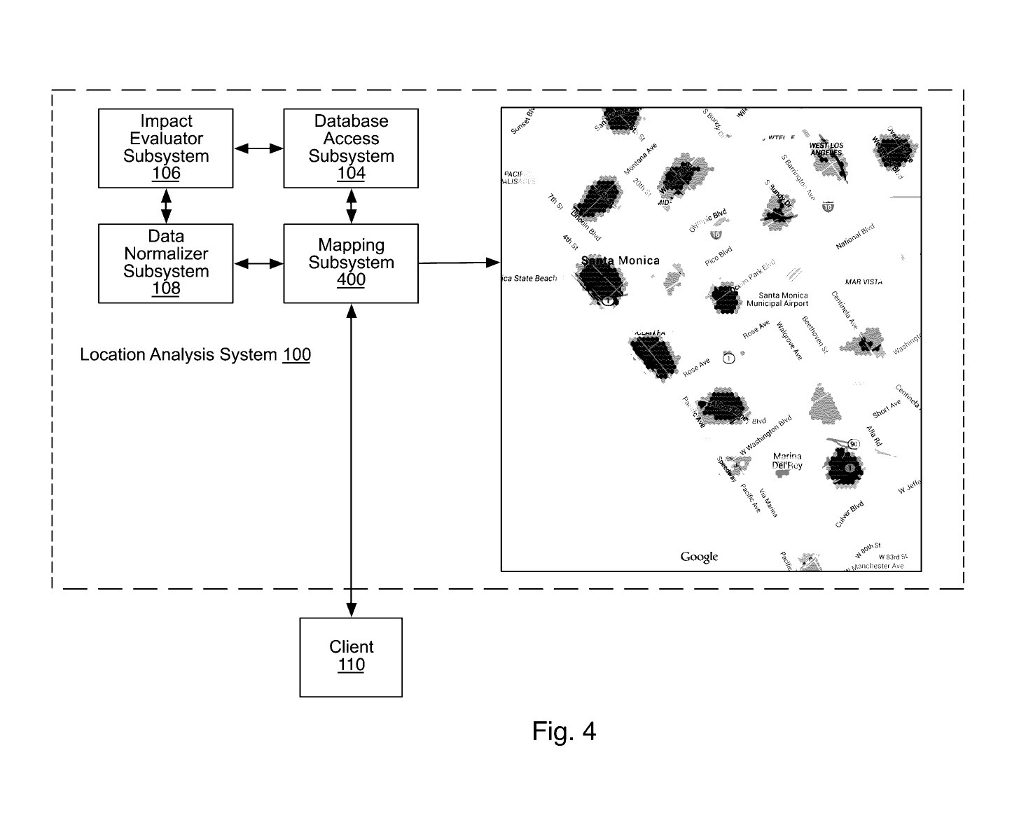

FIG. 4 shows a mapping subsystem 400 in one or more embodiments of the location analysis system 100. The mapping subsystem 400 generates a heat map 402 by determining a quality score for each of a set of grid locations in a predetermined geographic area and generating a visual indicator on the heat map 402 that depicts a magnitude and location of each quality score.

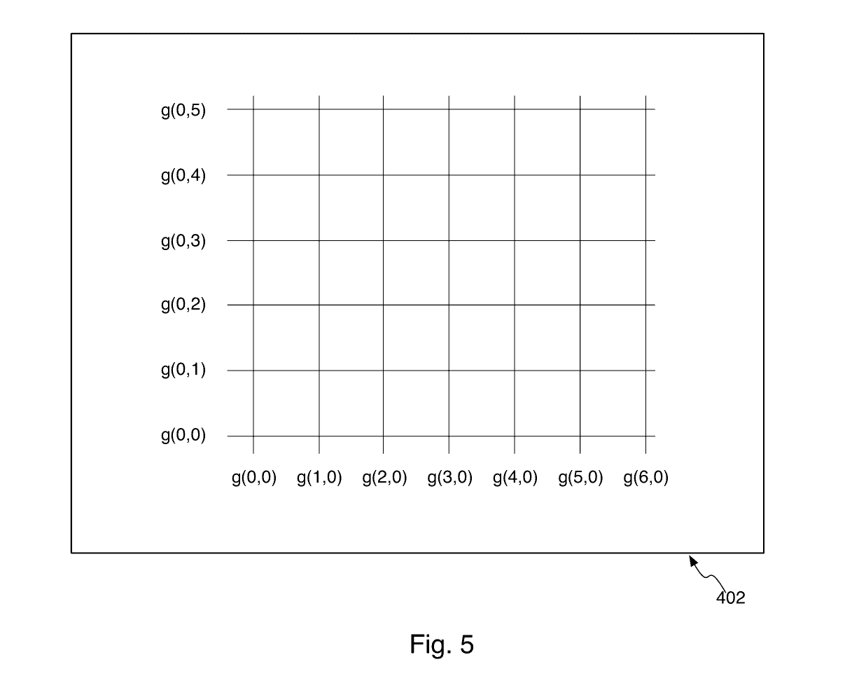

FIG. 5 shows how the predetermined geographic area for the heat map 402 can be represented in the mapping subsystem 400 by an array of grid locations including an array of example grid locations g(0,0) through g(6,5). The mapping subsystem 400 can determine an array of quality scores q(0,0) through q(6,5) for the grid locations g(0,0) through g(6,5) by feeding a geographic location of each grid location g(0,0) through g(6,5) to the database access system 104 as if it were an identified geographic location for a venue of a specified type of establishment and obtaining a resultant quality score from the data normalizer subsystem 108 and assembling the obtained quality scores in the array of quality scores q(0,0) through q(6,5).

The mapping subsystem 400 can convert each quality score q(0,0) through q(6,5) into a corresponding visual indicator of quality for the heat map 402, e.g., by converting quality score values into colors. For example, the color red can indicate highest quality and the colors green and yellow can indicate lower qualities. The mapping subsystem 400 can perform combining/smoothing (e.g., averaging) of adjacent quality scores q(0,0) through q(6,5) to fill in areas between and around the grid locations g(0,0) through g(6,5).

The predetermined geographic area for the heat map 402 can be specified by a user of a client 110, e.g., via a web based or mobile app interface to the mapping subsystem 400. The heat map 402 can be one of a set of pre-generated heat maps that are accessible via the client 110.

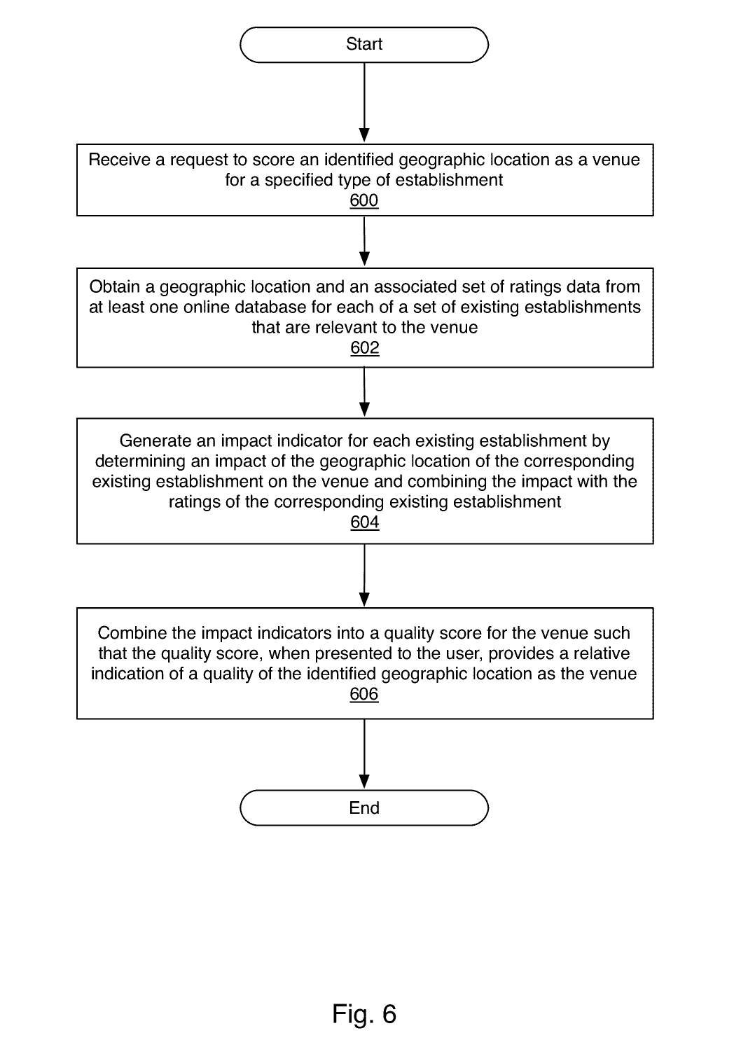

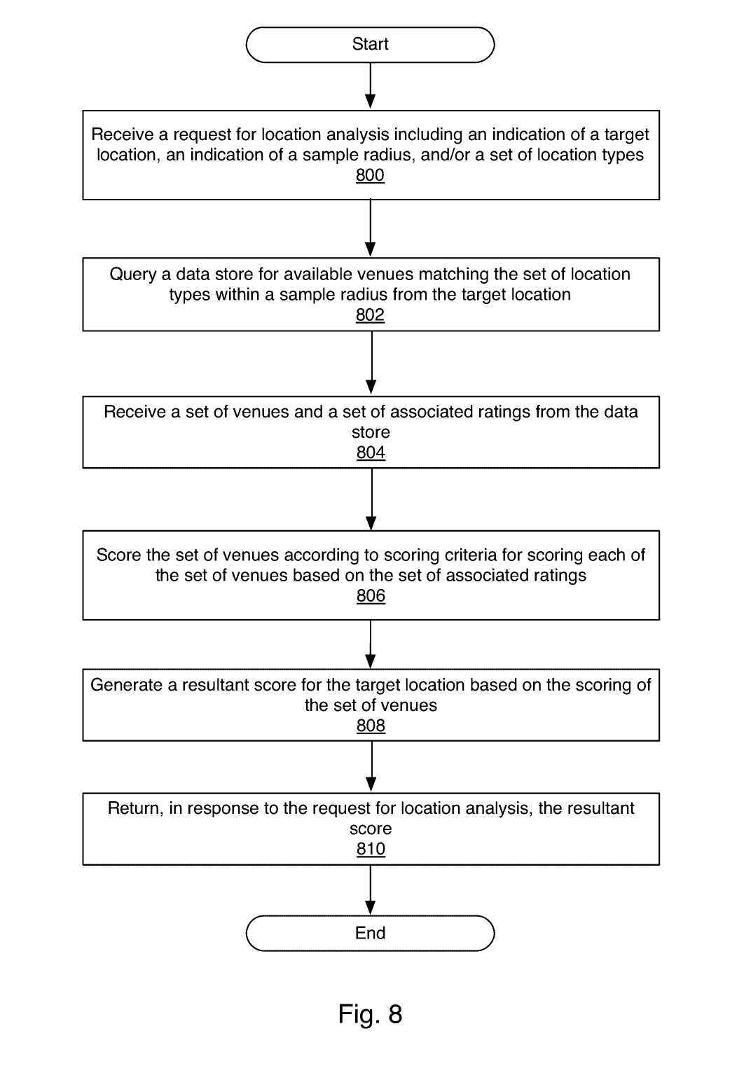

FIG. 6 is a flowchart of a method for rating-aware location analysis in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIGS. 6 and 8 should not be construed as limiting the scope of the invention.

In STEP 600, a request to score an identified geographic location as a venue for a specified type of establishment may be received. The request can be obtained via web or other network input from a user. The identified geographic location can be, e.g., GPS or other coordinates or a street address, generated by a mobile device or other web device or entered by a user of a mobile or other web device.

In STEP 602, a geographic location and an associated set of ratings data may be obtained from at least one online database for each of a set of existing establishments that are relevant to the venue. The relevancy of the existing establishments can be based on distance from the venue under consideration or on type of establishment or both.

In STEP 604, an impact indicator may be generated for each existing establishment by determining an impact of the geographic location of the corresponding existing establishment on the venue and combine the impact with the ratings of the corresponding existing establishment. An impact of the geographic location of an existing establishment can be based on distance to the venue.

In STEP 606, the impact indicators may be combined into a quality score for the venue such that the quality score, when presented to the user, provides a relative indication of a quality of the identified geographic location as the venue. The impact indicators can be culled before being combined. The quality score can be a normalized product of impact indicators. The quality score can be made into a visual indicator for a heat map.

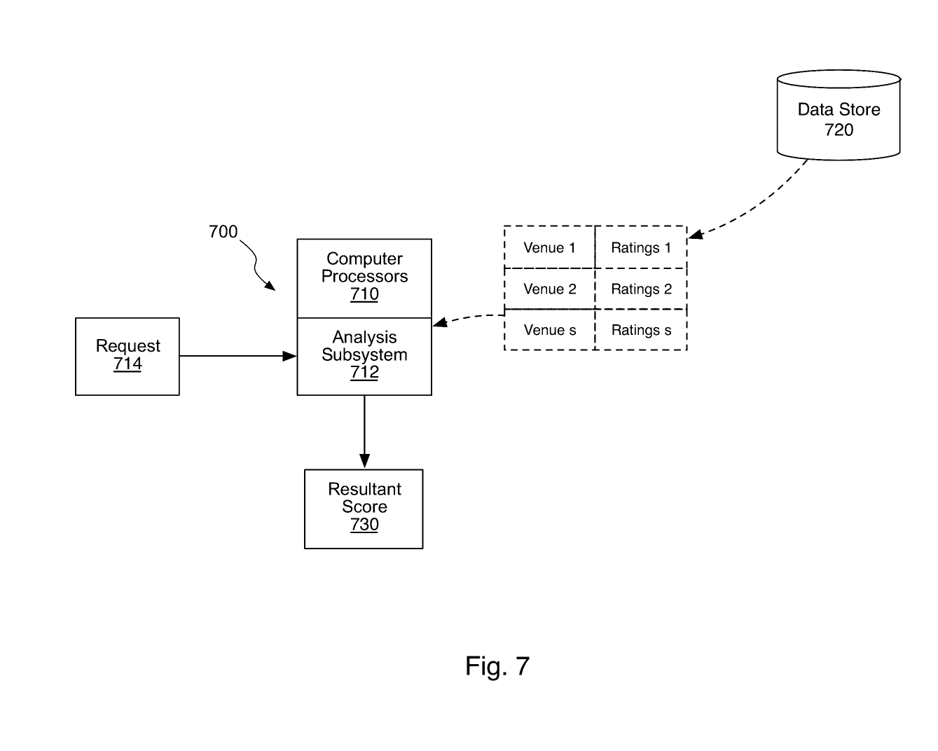

FIG. 7 shows a system 700 for rating-aware location analysis in one or more embodiments. The system 700 may include a set of one or more computer processors 710 and an analysis subsystem 712 executing on the computer processors 710 and configured to enable the computer processors 710 perform rating-aware location analysis.

The analysis subsystem 712 may receive a request 714 for location analysis. The request 712 can include an indication of a target location, an indication of a sample radius, and/or a set of location types. The analysis subsystem 712 may query a data store 720 for available venues matching the set of location types within the sample radius from the target location. In some embodiments, the request 712 includes an indication of a target location but not an indication of a sample radius and/or a set of location types (e.g., the analysis subsystem 712 may instead determine the sample radius and/or the set of location types). In some embodiments, the analysis subsystem 712 determines the target location, the sample radius, and/or the set of location types. For example, the analysis subsystem 712 may determine a target location based on a user's client device (e.g., based on an IP address, session information associated with an IP address, or GPS information), a sample radius based on an availability of proximate venues (e.g., a greater radius for lower density venue areas), and the set of location types based on a user profile (e.g., previously set user preferences or historical user behavior) or any other indicator.

The sample radius can be a distance, a number of street blocks, a driving distance, a walking distance, or a transit time, to name a few examples. Example location types include a retail business venue, a business-to-business venue, a wholesale venue, and a professional services venue.

The analysis subsystem 712 may receive a set of venues 1−s and a set of associated ratings 1−s from the data store 720. The analysis subsystem 712 may score the venues 1−s according to one or more scoring criteria. The scoring criteria can be used to score each venue 1−s based on the set of associated ratings 1−s. The scoring criteria can be based on a numerical rating in the associated ratings 1−s (e.g., a rating of 3 out of 5 stars). The scoring criteria can be based on a total number of ratings (e.g., a venue with 500 rating of 4/5 stars may be weighted positively (e.g., favorably) with respect to a venue with 1 rating of 4/5 stars). The scoring criteria can be based on the location type of a venue (e.g., a jewelry store may be weighted positively (e.g., favorably) because jewelry stores may tend to be located in preferable areas). The scoring criteria can be based on distances from the venues to the target location, location types associated with the venues or the target location, or any combination of these factors.

The scoring criteria can be based on text-based reviews or comments in the associated ratings 1−s. For example, the analysis subsystem 712 may perform text-based language processing and analysis on user-submitted reviews or comments. For example, keywords found in reviews/comments can be classified as positive or negative including degrees of positivity and negativity which can be used to score each venue. The user-submitted comments may be from social networking websites, e.g., user account news feed posts, status updates, message broadcasts, and the like. The analysis subsystem 712 may access such social networking comments through the associated ratings 1−s or otherwise (e.g., by querying a social networking platform for such comments).

In some embodiments, the analysis subsystem 712 may query a data store 720 for all available venues within the sample radius from the target location and filter out venues not matching the set of location types. For example, if and when location types related to restaurants include inconsistent ratings, location types related to restaurants may be filtered out. In another example, only location types related to restaurants may be used when analyzing a location based on or for restaurants.

The analysis subsystem 712 may generate a resultant score 730 for the target location based on the scoring of the venues 1−s. The analysis subsystem 712 may return, in response to the request for location analysis, the resultant score 730. The resultant score 730 may indicate a “retail grade” of the target location (e.g., a rating for the target location as a retail establishment). The resultant score 730 may also or instead indicate other grades, e.g., a “commercial grade” of the target location (e.g., a rating for the target location as a commercial property). The resultant score 730 may be used to determine a purchase or rental value of the target location (which may be used by a landlord/renter or buyer/seller to determine a rental or purchase price, respectively). The resultant score 730 may also correspond to foot traffic levels (e.g., of shoppers). For example, foot traffic levels may be relevant to a retail establishment and may be a significant consideration for a retail establishment.

The analysis subsystem 712 may generate, based on scoring the venues 1−s, a result set identifying a top scoring subset of the venues 1−s, calculate a score product of the scores of the venues 1−s, and produce the resultant score 730 by normalizing the score product into a range.

The analysis subsystem 712 may be configured to enable the computer processors 710 to receive the indication of the target location via a global positioning system (GPS) subsystem of a mobile device. The indication of a target location can be longitude/latitude coordinates, a street address, a mailing address, a cross street indication, a GPS coordinate, a city indication, a ZIP code indication, a building name, a business name, or a transit stop, to name a few examples.

The analysis subsystem 712 may be configured to enable the computer processors 710 to analyze a set of commentary pertaining to the ratings 1−s (as discussed in this disclosure). The analysis can include searching for one or more keywords in the set of commentary.

The analysis subsystem 712 may be configured to enable the computer processors 710 to normalize the scores of the subset of venues 1−s by distributing the scores into a predetermined range of scores.

The analysis subsystem 712 may be configured to enable the computer processors 710 to generate a heat map data set based on the scoring of the set of venues and associated venue locations, and return, in response to the request 714, the heat map data set. The heat map data set may be operable to be used to display a heat map by a client device. A heat map may be used to determine the score values for multiple locations or areas (instead of only a specific target location). In one example, such a heat map may be pertinent to landlords/renters or buyers/seller to determine a rental or purchase price, respectively. In another example, such a heat map may be pertinent to potential shoppers desiring to discover favorable shopping locations (e.g., a shopper visiting a new area or desiring to discover shopping areas unknown to the shopper). In yet another example, such a heat map may be pertinent to potential restaurant patrons desiring to discover favorable restaurant locations (e.g., if the location analysis is limited to restaurant location types).

FIG. 8 is a flowchart of a method for rating-aware location analysis in one or more embodiments. In STEP 800, a request for location analysis may be received including an indication of a target location, an indication of a sample radius, and/or a set of location types. In STEP 802, a data store may be queried for available venues matching the location types and within the sample radius from the target location. The data store can be a public or private data store using a public or private API for access. In STEP 804, a set of venues and a set of associated ratings may be received from the data store. In STEP 806, the set of venues may be scored according to scoring criteria for scoring each of the set of venues based on the set of associated ratings. The scoring criteria can be based on distances from the venues to the target location or location types associated with the venues or the target location or any combination of these factors. In STEP 808, a resultant score may be generated for the target location based on the scoring of the set of venues. In STEP 810, the resultant score may be returned in response to the request for location analysis.

Although the components of the systems 100 and 700 are depicted as being directly communicatively coupled to one another, this is not necessarily the case. For example, one or more of the components of the systems 100 and 700 may be communicatively coupled via a distributed computing system, a cloud computing system, or a networked computer system communicating via the Internet.

Although only one set of computer processors 710 is illustrated, it should be appreciated that this one computer system may represent many computer systems, arranged in a central or distributed fashion. For example, such computer systems may be organized as a central cloud and/or may be distributed geographically or logically to edges of a system such as a content delivery network or other arrangement. It is understood that virtually any number of intermediary networking devices, such as switches, routers, servers, etc., may be used to facilitate communication.

While the present disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. Some of the steps may be performed simultaneously. For example, in certain circumstances, multitasking and parallel processing may be advantageous. The various example methods described and/or illustrated herein may also omit one or more of the steps described or illustrated herein or include additional steps in addition to those disclosed.

Embodiments may be implemented on a specialized computer system. The specialized computing system can include one or more modified mobile devices (e.g., laptop computer, smart phone, personal digital assistant, tablet computer, or other mobile device), desktop computers, servers, blades in a server chassis, or any other type of computing device(s) that include at least the minimum processing power, memory, and input and output device(s) to perform one or more embodiments.

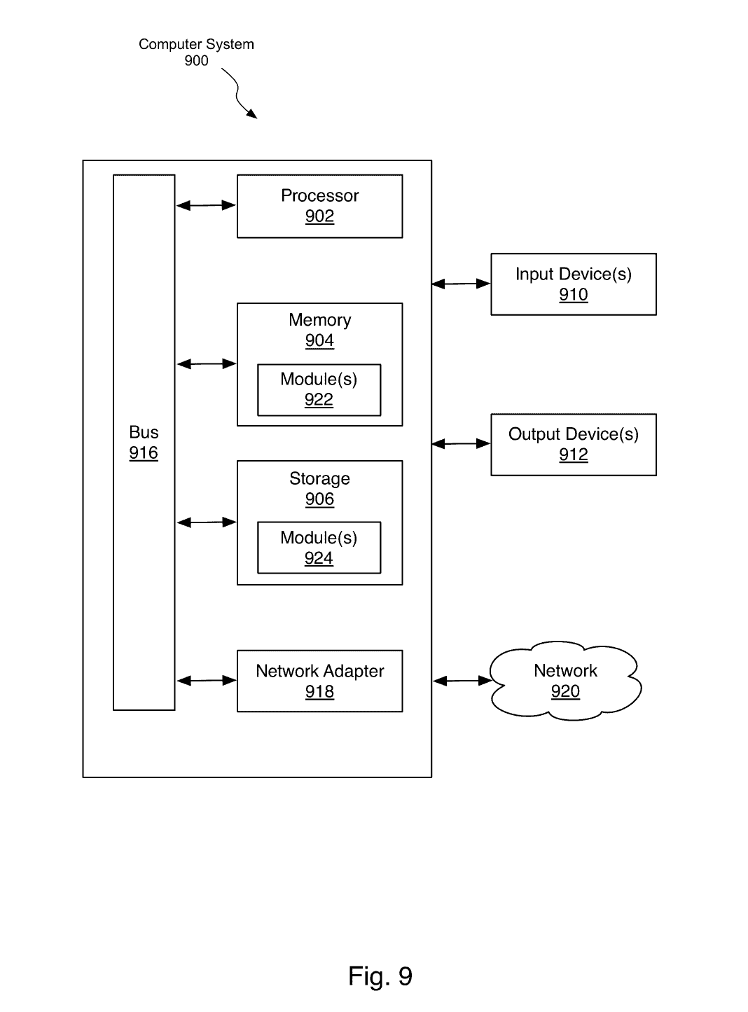

For example, as shown in FIG. 9, the computing system 900 may include one or more computer processor(s) 902, associated memory 904 (e.g., random access memory (RAM), cache memory, flash memory, etc.), one or more storage device(s) 906 (e.g., a hard disk, an optical drive such as a compact disk (CD) drive or digital versatile disk (DVD) drive, a flash memory stick, etc.), a bus 916, and numerous other elements and functionalities. The computer processor(s) 902 may be an integrated circuit for processing instructions. For example, the computer processor(s) may be one or more cores or micro-cores of a processor.

In one or more embodiments, the computer processor(s) 902 may be an integrated circuit for processing instructions. For example, the computer processor(s) 902 may be one or more cores or micro-cores of a processor. The computer processor(s) 902 can implement/execute software modules, systems, and/or subsystems stored by computing system 900, such as module(s) 922 stored in memory 904 or module(s) 924 stored in storage 906. For example, one or more of the modules or subsystems described in FIGS. 1, 4, and 7 (e.g., the location analysis system 100 or analysis subsystem 712) can be stored in memory 704 or storage 706, where they can be accessed and processed by the computer processor 702. In one or more embodiments, the computer processor(s) 902 can be a special-purpose processor where software instructions are incorporated into the actual processor design.

The computing system 900 may also include one or more input device(s) 910, such as a touchscreen, keyboard, mouse, microphone, touchpad, electronic pen, or any other type of input device. Further, the computing system 900 may include one or more output device(s) 912, such as a screen (e.g., a liquid crystal display (LCD), a plasma display, touchscreen, cathode ray tube (CRT) monitor, projector, or other display device), a printer, external storage, or any other output device. The computing system 900 may be connected to a network 920 (e.g., a local area network (LAN), a wide area network (WAN) such as the Internet, mobile network, or any other type of network) via a network interface connection 918. The input and output device(s) may be locally or remotely connected (e.g., via the network 920) to the computer processor(s) 902, memory 904, and storage device(s) 906.

One or more elements of the aforementioned computing system 900 may be located at a remote location and connected to the other elements over a network 920. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface.

One or more elements of the above-described systems (e.g., FIGS. 1, 4, and 7) may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems (e.g., FIGS. 1, 4, and 7) and/or flowcharts (e.g., FIGS. 6 and 8). Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

It is understood that a “set” can include one or more elements. It is also understood that a “subset” of the set may be a set of which all the elements are contained in the set. In other words, the subset can include fewer elements than the set or all the elements of the set (i.e., the subset can be the same as the set).

While the invention has been described with respect to a limited number of embodiments, those skilled in the art, having benefit of this disclosure, will appreciate that other embodiments may be devised that do not depart from the scope of the invention as disclosed herein.

What is claimed is:

1. A system for rating-aware and query-based location analysis, the system comprising:
one or more computer processors;
a location query subsystem executing on the one or more computer processors and configured to enable the one or more computer processors to receive a request to score an identified geographic location as a venue for a specified type of establishment;
a database access subsystem executing on the one or more computer processors and configured to enable the one or more computer processors to obtain, from at least one online database, a geographic location and an associated set of ratings data for each of a set of existing establishments that are relevant to the venue;
an impact evaluator subsystem executing on the one or more computer processors and configured to enable the one or more computer processors to generate, for each existing establishment, an impact indicator by determining an impact of the geographic location of the corresponding existing establishment on the venue and combining the impact with the ratings of the corresponding existing establishment; and
a data normalizer subsystem executing on the one or more computer processors and configured to enable the one or more computer processors to combine the impact indicators into a quality score such that the quality score, when presented to a user via the location query subsystem, provides a relative indication of a quality of the identified geographic location as the venue.

2. The system of claim 1, wherein the database access subsystem is further configured to enable the one or more computer processors to select the existing establishments from the online database that are relevant to the venue based on a type indicator associated with each existing establishment.

3. The system of claim 1, wherein the database access subsystem is further configured to enable the one or more computer processors to select the existing establishments from the online database that are relevant to the venue based on a maximum allowed distance of the existing establishments from the venue.

4. The system of claim 3, wherein the impact evaluator subsystem is further configured to enable the one or more computer processors to determine the impact indicators by determining a distance factor for each existing establishment based on a geographical distance between the identified geographic location and the existing establishment and the maximum allowed distance.

5. The system of claim 4, wherein the impact evaluator subsystem is further configured to enable the one or more computer processors to determine the impact indicators by normalizing the corresponding ratings and determining a ratio of the corresponding ratings to the corresponding distance factor.

6. The system of claim 1, wherein the data normalizer is further configured to enable the one or more computer processors to cull the impact indicators by discarding all but a predetermined number of the impact indicators corresponding to a set of highest values among the impact indicators.

7. The system of claim 1, wherein the location query subsystem is further configured to enable the one or more computer processors to obtain the request by generating a web-based user interface that enables the user to specify the identified geographic location and select the specified type of establishment.

8. The system of claim 1, further comprising a mapping subsystem configured to enable the one or more computer processors to generate a heat map by determining a quality score for each of a set of grid locations in a predetermined geographic area and generating a visual indicator on the heat map that depicts the corresponding quality score.

9. A method, implemented by one or more computer processors, for rating-aware location analysis, comprising:
receiving a request to score an identified geographic location as a venue for a specified type of establishment;
obtaining a geographic location and an associated set of ratings data from at least one online database for each of a set of existing establishments that are relevant to the venue;
generating an impact indicator for each existing establishment by determining an impact of the geographic location of the corresponding existing establishment on the venue and combining the impact with the ratings of the corresponding existing establishment; and
combining the impact indicators into a quality score for the venue such that the quality score, when presented to the user, provides a relative indication of a quality of the identified geographic location as the venue.

10. The method of claim 9, wherein obtaining a geographic location and an associated set of ratings data comprises selecting the existing establishments from the online database based on a type indicator associated with each existing establishment.

11. The method of claim 9, wherein obtaining a geographic location and an associated set of ratings data comprises selecting the existing establishments from the online database based on a distance of the existing establishments from the venue.

12. A system for rating-aware location analysis, the system comprising:
one or more computer processors;
an analysis subsystem executing on the one or more computer processors and configured to enable the one or more computer processors to:
receive a request for location analysis comprising an indication of a target location;
query a data store for available venues matching a set of location types within a sample radius from the target location;
receive a set of venues and a set of associated ratings from the data store;
score the set of venues according to scoring criteria, wherein the scoring criteria is used to score each of the set of venues based on the set of associated ratings;
generate a resultant score for the target location based on the scoring of the set of venues; and
return, in response to the request for location analysis, the resultant score.

13. The system of claim 12, wherein the analysis subsystem, in generating a resultant score, is further configured to enable the one or more computer processors to:
generate, based on scoring the set of venues, a result set identifying a top scoring subset of the set of venues;
calculate a score product of the scores of the subset of venues; and
produce the resultant score by normalizing the score product into a range.

14. The system of claim 12, wherein the analysis subsystem is further configured to enable the one or more computer processors to receive the indication of the target location via a global positioning system (GPS) subsystem of a mobile device.

15. The system of claim 12, wherein the analysis subsystem is further configured to enable the one or more computer processors to analyze a set of commentary pertaining to the ratings, wherein analysis includes searching for one or more keywords in the set of commentary.

16. The system of claim 12, wherein the analysis subsystem is further configured to enable the one or more computer processors to normalize the scores of the subset of venues by distributing the scores into a predetermined range of scores.

17. The system of claim 12, wherein the indication of a target location comprises at least one selected from a group consisting of longitude/latitude coordinates, a street address, a mailing address, a cross street indication, a GPS coordinate, a city indication, a ZIP code indication, a building name, a business name, and a transit stop.

18. The system of claim 12, wherein the sample radius comprises at least one selected from a group consisting of a distance, a number of street blocks, a driving distance, a walking distance, and a transit time.

19. The system of claim 12, wherein the set of location types comprises at least one selected from a group consisting of a retail business venue, a business to business venue, a wholesale venue, and a professional services venue.

20. The system of claim 12, wherein the analysis subsystem is further configured to enable the one or more computer processors to:
generate a heat map data set based on the scoring of the set of venues and associated venue locations, wherein the heat map data set is operable to be used to display a heat map by a client device; and
return, in response to the request for location analysis, the heat map data set.
